(19) United States
(12) Patent Application Publication
(10) Pub. No.: US 2012/0237270 A1
(43) Pub. Date: Sep. 20, 2012

(54) DEVELOPING ROLLER

(76) Inventors: Keiichiro JURI, Osaka (JP); Chiyoshi Nozaki, Shiga (JP); Hideaki Yasunaga, Osaka (JP); Shuuichi Nakagawa, Osaka (JP)

(21) Appl. No.: 13/422,739

(22) Filed: Mar. 16, 2012

(30) Foreign Application Priority Data
Mar. 18, 2011 (JP) 2011-060198
Mar. 5, 2012 (JP) 2012-047856

(51) Int. Cl. G03G 15/08

(52) U.S. Cl. 399/284; 399/286

(57) ABSTRACT

A developing roller including: an electrically-conductive base; an elastic layer formed on an outer circumference of the electrically-conductive base; and a toner bearing layer formed on the elastic layer, wherein the toner bearing layer contains a polyurethane resin having an isocyanurate structure, and wherein the polyurethane resin has a ratio A/B of 1.0 to 10.0 where A denotes absorbance attributed to C═O of cyanurate and B denotes absorbance attributed to C═O of urethane in an infrared absorption spectrum of the polyurethane resin obtained by an ATR method.

### BACKGROUND OF THE INVENTION

1. Field of the Invention

The present invention relates to a developing roller that causes toner charge to start quickly, causes an image lag not to be generated even with the lapse of time, and allows the formation of a high-quality image.

2. Description of the Related Art

With the recent trends of life extension, downsizing, and price reduction in a printer of a monocomponent development system, each member is required to have a low cost and a high durability, and a whole development system itself is required to have a simple structure and supply a stable and high-quality image for a long period of time.

In the monocomponent development system, development is performed by conveying toner from a feed roller to a developing roller, forming a thin layer of charged toner by passing the toner through a gap between regulation blades coming into contact with the developing roller, and moving it from the developing roller onto a latent image of a photoconductor by an electric field. Therefore, in order to supply a high-quality image stably with the lapse of time, it is important to quicken the startup of toner charge with the lapse of time at a developing roller and many technological measures are proposed.

In Japanese Patent Application Laid-Open (JP-A) No. 2007-225832 for example, disclosed is a method of: forming a toner bearing layer by using a reactant of a polyurea compound and a polyurethane compound; reducing frictional force and/or frictional heat against toner; preventing the filming of a toner component from being generated; and preventing image failures such as fogging of white images, the roughness of halftone images, and shading unevenness of black images from being generate.

In recent years, however, speedup and image micronization have been demanded strenuously and problems that cannot be solved with a conventional toner bearing member have been revealed. That is, a problem arises in which when the startup of toner charge is slow, it takes a long time until the charge of toner reaches a saturating amount and an image lag is generated in images.

### SUMMARY OF THE INVENTION

An object of the present invention is to provide a developing roller that can accelerate the startup of toner charge and prevent an image lag from forming.

As a result of earnest studies by the present inventors for solving the above problems, it has been found that, by adding an isocyanate group (NCO) of polyisocyanate to a hydroxyl group (OH) of polyol excessively in forming polyurethane resin of a toner bearing layer: the isocyanate group remaining without not being converted into urethane forms a urea bond, an allophanate bond, a cyanurate ring, via amine; the charging ability of the toner bearing layer is enhanced; and the startup of toner charge can be accelerated. That is, it has been found that: a structure derived from isocyanate such as the urea bond, the allophanate bond, the cyanurate ring has a positive electrostatic property; and thus the positive charging ability is enhanced by the structure derived from the redundant isocyanate group; and a developing roller that can accelerate the startup of toner charge and prevent an image lag from being generated can be provided.

The present invention is based on the above findings by the present inventors and the means for solving the above problems are as follows. That is, a developing roller according to the present invention is one having an electrically-conductive base, an elastic layer formed around the outer circumference of the electrically-conductive base, and a toner bearing layer formed on the elastic layer, in which the toner bearing layer contains polyurethane resin having an isocyanurate structure and, in the polyurethane resin having the isocyanurate structure, a ratio (A/B) of the absorbance A of C═O in cyanurate to the absorbance B of C═O in urethane is 1.0 to 10.0 in an infrared absorption spectrum obtained by an ATR method.

The present invention makes it possible to solve the above conventional problems, attain the above objects, and provide a developing roller that causes toner charge to start quickly and causes an image lag not to be generated even with the lapse of time.

### BRIEF DESCRIPTION OF THE DRAWINGS

FIG. 1 is a spectrum, measured by an ATR method, of the surface layer of a developing roller prepared according to Comparative Example 1.

FIG. 2 is a spectrum, measured by an ATR method, of the surface layer of a developing roller prepared according to Example 2.

FIG. 3 is a spectrum, measured by an ATR method, of the surface layer of a developing roller prepared according to Example 6.

FIG. 4 is a schematic view showing an example of an image forming apparatus.

FIG. 5 is a schematic view showing an example of a process cartridge.

FIG. 6 is an image pattern used for image lag evaluation.

### DETAILED DESCRIPTION OF THE INVENTION

### Developing Roller

A developing roller according to the present invention includes: an electrically-conductive base; an elastic layer formed on an outer circumference of the electrically-conductive base; and a toner bearing layer formed on the elastic layer, and further includes other layers if necessary.

### <Electrically-Conductive Base>

The shape, structure, size and material of the electrically-conductive base are not particularly limited and can be appropriately selected depending on the purpose. For example, the shape may be a columnar solid body or a cylindrical shape having a hollow interior, the structure includes a single-layered structure or a laminated structure, and the size may be appropriately selected in accordance with the size of a developing roller.

The electrically-conductive base exhibiting an electrical conductivity of 10¹⁰ Ω·cm or less in volume resistance is preferably used.

As the electrically-conductive base for example, there can be used: (1) a metallic base formed of, for example, iron, aluminum, stainless steel or brass; (2) a base formed by plating the surface of a core body comprising thermoplastic resin or thermosetting resin with a metallic film; (3) a base formed by vapor-depositing a metallic film on the surface of a core body comprising thermoplastic resin or thermosetting resin; (4) a base integrally formed with a resin composite produced by blending, for example, carbon black and metallic powder as an electrical conductivity adding agent with thermoplastic resin or thermosetting resin.

### <Elastic Layer>

The elastic layer contains an elastic material, an electrically-conductive agent, and further contains other components if necessary.

A preferable elastic layer preferably exhibits an electric conductivity of 10¹⁰ Ω·cm or less in volume resistance.

Elastic Material

The elastic material is not particularly limited and can be appropriately selected depending on the purpose. Examples thereof are silicon rubber, ethylene-propylene-butadiene rubber, polyurethane rubber, chloroprene rubber, natural rubber, butyl rubber, polyisoprene rubber, polybutadiene rubber, styrene-butadiene rubber, nitrile rubber, ethylene-propylene rubber, acrylic rubber, epichlorohydrin rubber, or rubber or elastomer including a mixture of those. Those may be used alone or as a combination of two or more kinds.

Among them, epichlorohydrin rubber is used particularly preferably since it has an appropriate hardness.

Electrically-Conductive Agent

The electrically-conductive agent is not particularly limited and can be appropriately selected depending on the purpose. For example, an ion-conductive agent or an electron-conductive agent is used.

The ion-conductive agent is not particularly limited and can be appropriately selected depending on the purpose. Examples thereof include: ammonium salts including perchlorate, chlorate, hydrochloride, bromate, iodate, hydroborofluorate, sulfate, ethyl sulfate, carboxylate, and sulfonate of tetraethyl-ammonium, tetrabutyl-ammonium, dodecyl trimethyl-ammonium (for example, lauryl trimethyl-ammonium), hexadecyl trimethyl-ammonium, octadecyl trimethyl-ammonium (for example, stearyl trimethyl-ammonium), modified fatty acid dimethylethyl-ammonium, and lauryl trimethyl-ammonium chloride; and perchlorate, chlorate, hydrochloride, bromate, iodate, hydroborofluorate, trifluoromethyl sulfate, and sulfonate of alkali metals and alkali earth metals such as lithium, sodium, potassium, calcium, and magnesium.

The electron-conductive agent is not particularly limited and can be appropriately selected depending on the purpose. Examples thereof are: electrically-conductive carbon such as ketjen black or acetylene black; carbon for rubber such as SAF, ISAF, HAF, FEF, GPF, SRF, FT, or MT; carbon for ink subjected to oxidation treatment, pyrolytic carbon, natural graphite, or artificial graphite; electrically-conductive metallic oxide such as tin oxide, titanium oxide, or zinc oxide; and metal such as nickel, copper, silver, or germanium. Those may be used alone or as a combination of two or more kinds.

The quantity of an electrically-conductive agent to be added is not particularly limited and can be appropriately selected depending on the purpose. In the case of an ion-conductive agent, the quantity thereof is preferably 0.01 parts by mass to 5 parts by mass and more preferably 0.05 parts by mass to 2 parts by mass relative to 100 parts by mass of the elastic material. In the case of an electron-conductive agent, the quantity thereof is preferably 1 part by mass to 50 parts by mass and more preferably 5 parts by mass to 40 parts by mass relative to 100 parts by mass of the elastic material.

Other Components

Examples of the other components include a softener, a vulcanizer, a processing aid, an anti-aging agent, a filler, and a reinforcing agent.

The average thickness of the elastic layer is not particularly limited and can be appropriately selected depending on the purpose. A preferable average thickness thereof is, for example, 1 mm to 10 mm.

### <Toner Bearing Layer>

The toner bearing layer contains polyurethane resin having an isocyanurate structure, an electrically-conductive material, and a filler, and further contains other components if necessary.

Polyurethane Resin Having Isocyanurate Structure

The polyurethane resin having an isocyanurate structure can be obtained by (1) reaction between polyisocyanate and polyol and/or mutual reaction among redundant polyisocyanate molecules in a reaction system of redundant polyisocyanate and polyol and (2) reaction between polyisocyanate and amine. However, care should be taken because bubbles may sometimes be caused by an undesirably heated and evaporated solvent in the reaction between polyisocyanate and amine.

The polyurethane resin having an isocyanurate structure is preferably a polymer of polyol and polyisocyanate prepolymer forming an isocyanurate compound.

Here, the polyisocyanate prepolymer forming the isocyanurate compound means a polyfunctional compound formed of bifunctional isocyanates.

It is preferable that the polyisocyanate prepolymer contains polyisocyanate having two or more isocyanate (NCO) groups.

The polyisocyanate is not particularly limited and can be appropriately selected depending on the purpose. Examples thereof are: isocyanate such as methylene diphenyl diisocyanate (MDI), tolylene diisocyanate (TDI), xylylene diisocyanate (XDI), naphthylene-1,5-diisocyanate (NDI), tetramethyl xylene diisocyanate (TMXDI), isophorone diisocyanate (IPDI), hydrogenated xylylene diisocyanate (H₆XDI), dicyclohexyl methane diisocyanate (H₁₂MDI), hexamethylene diisocyanate (HDI), dimer acid diisocyanate (DDI), norbornene diisocyanate (NBDI), and trimethyl hexamethylene diisocyanate (TMDI); and an adduct and an isocyanurate compound thereof. Those may be used alone or as a combination of two or more kinds.

Among them, at least one of tolylene diisocyanate, hexamethylene diisocyanate, and an isocyanurate compound thereof is preferably used since the residual isocyanate is relatively low in reactivity and the pot life can be extended. Particularly preferable is an isocyanurate compound of hexamethylene diisocyanate.

As such an isocyanurate compound, a commercially available one can be used and examples of the commercially available one are an isocyanurate compound of hexamethylene diisocyanate (D170N manufactured by Mitsui Chemicals, Inc.) and an isocyanurate compound of tolylene diisocyanate (D262 manufactured by Mitsui Chemicals, Inc.).

The polyol is a compound having two or more hydroxyl groups and may be various polyalcohols such as ethylene glycol, 1,4-butadiene glycol, polyethylene glycol, polypropylene glycol, polyether polyol, and polycarbonate diol. Among them, those having a relatively high molecular weight are preferably used.

A preferable number-average molecular weight Mn of the polyol is 10,000 to 40,000.

As the polyol, a commercially available one can be used and examples of the commercially available one are: VYLON UR1350 (number-average molecular weight Mn=30,000, glass transition temperature Tg=3° C., hydroxyl value=46 mgKOH/g, acid value<1 mgKOH/g, linear type), VYLON UR1400 (number-average molecular weight Mn=40,000, glass transition temperature Tg=83° C., hydroxyl value=2 mgKOH/g, acid value<1 mgKOH/g, linear type), VYLON UR3210 (number-average molecular weight Mn=40,000, glass transition temperature Tg=−3° C., hydroxyl value=3 mgKOH/g, acid value<1 mgKOH/g, linear type), VYLON UR5537 (number-average molecular weight Mn=20,000, glass transition temperature Tg=34° C., hydroxyl value=17 mgKOH/g, acid value<1 mgKOH/g, linear type), and VYLON UR9500 (number-average molecular weight Mn=25,000, glass transition temperature Tg=15° C., hydroxyl value=5 mgKOH/g, acid value<1 mgKOH/g, linear type) [those being manufactured by Toyobo Co., Ltd.]; and TAKELAC E158 (hydroxyl value=20 mgKOH/g, acid value<3 mgKOH/g), TAKELAC E551T (hydroxyl value=30 mgKOH/g, acid value<3 mgKOH/g), and TAKELAC A2789 (hydroxyl value=10 mgKOH/g, acid value<2 mgKOH/g) [those being manufactured by Mitsui Chemicals Polyurethanes, Inc.]. Those may be used alone or as a combination of two or more kinds.

The polyurethane resin having the isocyanurate structure has a ratio A/B of 1.0 to 10.0 where A denotes absorbance attributed to C═O of cyanurate and B denotes absorbance attributed to C═O of urethane in an infrared absorption spectrum of the polyurethane resin obtained by an ATR method. If the ratio (A/B) of the absorbance is less than 1.0, it sometimes happens that the positive charging ability is insufficient and the startup of toner charge cannot be accelerated and, if it exceeds 10.0, it sometimes happens that the toner bearing layer deteriorates early.

Here, the ratio (A/B) of the absorbance is analyzed on the surface of the toner bearing layer with an FT-IR (FT-IR Spectrometer, manufactured by PerkinElmer Japan Co., Ltd.) by an ATR method. It is possible to: obtain a single peak (the vicinity of 1,680 cm⁻¹ to 1,690 cm⁻¹) of C═O in cyanurate and a single peak (the vicinity of 1,710 cm⁻¹ to 1,730 cm⁻¹) of C═O in urethane from the obtained IR spectrum; and calculate the ratio (A/B) of the absorbance A of C═O in cyanurate to the absorbance B of C═O in urethane.

The ratio (A/B) of the absorbance can be adjusted by adjusting the molar ratio of isocyanate groups (NCO) in polyisocyanate to hydroxyl groups (OH) in polyol, and the molar ratio (NCO/OH) is preferably 8 to 108, more preferably 30 to 100, although it depends on the polyisocyanate and the polyol used here.

If a molar ratio (NCO/OH) is less than 8, the coated film may have tackiness due to insufficiency of crosslinked points and, if it exceeds 108, toner easily forms filming on the developing roller to potentially cause severe background smear.

Electrically-Conductive Material

The electrically-conductive material is not particularly limited and can be appropriately selected depending on the purpose. Examples thereof are: electrically-conductive carbons such as ketjen black EC and acetylene black; carbons for rubber such as SAF, ISAF, HAF, FEF, GPF, SRF, FT, and MT; carbon for coloring subjected to oxidation treatment and pyrolytic carbon; metals and metallic oxides such as indium doped tin oxide (ITO), tin oxide, titanium oxide, zinc oxide, copper, silver, and germanium; and electrically-conductive polymers such as polyaniline, polypyrrole, and polyacetylene. Those may be used alone or as a combination of two or more kinds.

The content of the electrically-conductive agent in a toner bearing layer is not particularly limited and can be appropriately selected depending on the purpose. The content is preferably 1 part by mass to 50 parts by mass and more preferably 5 parts by mass to 40 parts by mass relative to 100 parts by mass of polyurethane resin having an isocyanurate structure.

Filler

As the filler, either an organic filler or an inorganic filler is used. Examples of the organic filler are: powder of fluororesin such as polytetrafluoroethylene; silicon resin powder; and a-carbon powder. Examples of the inorganic filler are: powder of metal such as copper, tin, aluminum, or indium; metallic oxide such as silica, tin oxide, zinc oxide, titanium oxide, alumina, zirconium oxide, indium oxide, antimony oxide, bismuth oxide, calcium oxide, antimony-doped tin oxide, or tin-doped indium oxide; metallic fluoride such as tin fluoride, calcium fluoride, or aluminum fluoride; potassium titanate; and boron nitride.

The average primary particle size of the filler is preferably 0.01 μm to 1.0 μm, more preferably 0.05 μm to 0.8 μm.

The content of the filler in a toner bearing layer is preferably 5% by mass to 50% by mass, more preferably 10% by mass to 40% by mass.

Examples of the other components include a solvent, a softener, a processing aid, an anti-aging agent, a filler, a reinforcing agent, and a lubricant.

The solvent is not particularly limited and can be appropriately selected depending on the purpose. Examples of the solvent are: ketone system solvents such as acetone, methyl ethyl ketone, and cyclohexanone; aromatic hydrocarbon system solvents such as toluene and xylene; aliphatic hydrocarbon system solvents such as hexane; alicyclic hydrocarbon system solvents such as cyclohexane; ester system solvents such as ethyl acetate and butyl acetate; ether system solvents such as isopropyl ether and tetrahydrofuran; amide system solvents such as dimethyl sulfoamide; halogenated hydrocarbon system solvents such as chloroform and dichloroethane; and a mixture of those solvents.

A method of forming the toner bearing layer is not particularly limited and can be appropriately selected depending on the purpose. An example of the method is a method of: dissolving or dispersing polyurethane resin having an isocyanurate structure, an electrically-conductive material, a filler, and other components in a solvent; coating an elastic layer with the mixture by, for example, a dipping method, a roll coater method, a doctor blade method, or a splaying method; and reacting and hardening them by drying them at ordinary temperature or a high temperature of about 50° C. to about 170° C.

The average thickness of the toner bearing layer is not particularly limited and can be appropriately selected depending on the purpose. For example, the average thickness thereof is preferably 1 μm to 100 μm and more preferably 5 μm to 30 μm.

### (Developing Device)

A developing device according to the present invention includes: a developing roller configured to bear on a surface thereof a developer to be supplied to a latent image bearing member; a developer supplying member configured to supply the developer onto the surface of the developing roller; a developer layer regulating member configured to form a thin layer of the developer on the surface of the developing roller; and a developer container which houses the developer; and further includes other units if necessary.

As the developing roller, a developing roller according to the present invention is used.

Developer Supplying Member

The developer supplying member is not particularly limited as long as it is a member configured to supply a developer onto the surface of a developer bearing member and can be appropriately selected depending on the purpose. An example thereof is a feed roller.

Developer Layer Thickness Regulating Member

The developer layer thickness regulating member: is a member to regulate the quantity of a developer attached onto a developing roller; is formed by using a metal plate spring material comprising stainless steel (SUS) or phosphor bronze and abutting the free end side to the developing roller surface at a predetermined pressing force; and forms the developer having passed through under the pressing force, into a thin layer.

The developer layer thickness regulating member is usually provided at a position lower than the position where a feed roller and a developing roller come into contact with each other.

Developer Container

The developer container is not particularly limited as long as it is a member that can house a developer and can be appropriately selected depending on the purpose.

### (Image Forming Apparatus)

An image forming apparatus according to the present invention includes: at least a latent image bearing member; a charging unit; an exposing unit; a developing unit; a transfer unit; and a fixing unit, and further includes other units appropriately selected if necessary such as an antistatic unit, a cleaning unit, a recycling unit, and a controlling unit for example. Here, the charging unit and the exposing unit may collectively be referred to as a latent image forming unit.

An image forming method according to the present invention includes: at least a charging step, an exposing step, a developing step, a transfer step, and a fixing step, and further includes other steps appropriately selected if necessary such as an antistatic step, a cleaning step, a recycling step, and a controlling step for example. Here, the charging step and the exposing step may collectively be referred to as a latent image forming step.

### <Latent Image Bearing Member>

The material, shape, structure, size and others of the latent image bearing member (hereunder may be referred to as “electrophotographic photoconductor” or “photoconductor”) are not particularly limited and can be appropriately selected from among known ones. A preferable shape thereof is a drum shape and examples of the material are inorganic photoconductors such as amorphous silicon and selenium and organic photoconductors such as polysilane and phthalopolymethine. Among these, amorphous silicon is preferable from the viewpoint of longer service life.

### <Charging Unit>

The charging step is a step of charging the surface of a latent image bearing member and is carried out by the charging unit.

Charging can be carried out by, for example, applying voltage to the surface of a latent image bearing member with a charger.

The charger is not particularly limited and can be appropriately selected depending on the purpose. Examples thereof include a contact charger publicly known in itself having a conductive or semi-conductive roller, a brush, a film, and a rubber blade, and non-contact chargers using corona discharge such as a corotron or a scorotron.

The charging unit may take any shape, may be a magnetic brush or a fur brush besides a roller, and can be selected in accordance with the specification and form of an electrophotographic image forming apparatus.

The charger is not limited to such a contact type charger but has the advantage that an image forming apparatus that reduces ozone generated from a charger is obtained.

### <Exposing Step and Exposing Unit>

The exposing step is a step of exposing a charged latent image bearing member surface and is carried out by the exposing unit.

The exposure can be carried out for example by exposing imagewise the surface of a latent image bearing member by the exposing unit.

An optical system in exposure is roughly classified into an analog optical system and a digital optical system. The analog optical system is an optical system of projecting a manuscript directly on a latent image bearing member by an optical system and the digital optical system is an optical system of forming an image by giving image information as an electric signal, converting the electric signal to an optical signal, and exposing an electrophotographic photoconductor.

The exposing unit is not particularly limited as long as the surface of a latent image bearing member charged by the charging unit can be exposed imagewise to be formed and can be appropriately selected depending on the purpose. Examples thereof include various exposure devices of a reproduction optical system, a rod lens array system, a laser optical system, a liquid crystal shutter optical system, and an LED optical system.

### <Developing Step and Developing Unit>

The developing step is a step of forming a visible image by developing an electrostatic latent image with toner or a developer.

The formation of the visible image can be carried out by, for example, developing an electrostatic latent image with toner or a developer and can be carried out by the developing unit.

The developing unit is not particularly limited for example as long as development can be carried out with toner or a developer and can be appropriately selected from among known unit. A preferable example thereof is a device housing toner or a developer and having at least a developing unit capable of giving the toner or the developer to an electrostatic latent image in a contact or noncontact manner, and a developing unit including a container containing toner is more preferable.

The developing unit may be of either a dry-development type or a wet-development type and may be either a monocolor developing unit or a multicolor developing unit.

In the developing unit for example, toner and a carrier are mixed and stirred, the toner is charged with electricity by the friction on this occasion, they are retained in the state of being in ear on the surface of a rotating magnet roller, and thus a magnetic brush is formed. Since the magnet roller is installed in the vicinity of a latent image bearing member, a part of the toner constituting the magnetic brush formed on the surface of the magnet roller moves toward the surface of the latent image bearing member by an electrical suction force. As a result, the electrostatic latent image is developed by the toner and a visible image is formed by the toner on the surface of the latent image bearing member. The developer stored in the developing unit is a developer containing toner and may be either a single component developer or a double component developer.

### <Transfer Step and Transfer Unit>

The transfer step is a step of transferring a visible image to a recording medium. A preferable aspect thereof is to: use an intermediate transfer member; primarily transfer a visible image on the intermediate transfer member; and then secondarily transfer the visible image on a recording medium. As the toner, toner of two or more colors or preferably full-color toner is used. Furthermore, a more preferable aspect thereof is to have a primary transfer step of transferring a visible image on an intermediate transfer member to form a composite transfer image, and a secondary transfer step of transferring the composite transfer image on a recording medium.

The transfer of a visible image can be carried out by, for example, charging a latent image bearing member through the use of a transfer charger and can be carried out by the transfer unit.

Meanwhile, the intermediate transfer member is not particularly limited and can be appropriately selected from among known transfer bodies depending on the purpose. A preferable example thereof is a transfer belt.

A preferable transfer unit (a primary transfer unit and a secondary transfer unit) is a unit at least having a transfer unit that exfoliates and electrically charges a visible image formed on a latent image bearing member, to the side of a recording medium. The transfer unit may be one unit or two or more units. Meanwhile, the recording medium is typically ordinary paper but is not particularly limited as long as it can transfer an image that is not yet fixed after being developed and can be appropriately selected depending on the purpose. A PET base for an OHP can be used as the recording medium.

### <Fixing Step and Fixing Unit>

The fixing step is a step of fixing a toner image transferred to a recording medium, and the toner image can be fixed by the fixing unit. Meanwhile, when toner of two or more colors is used, an image may be fixed either every time when toner of each color is transferred to a recording medium or in a state of transferring and stacking in layers toner of all colors to a recording medium. The fixing unit is not particularly limited and a heat fixing method by a known heating and pressurizing unit can be adopted.

### <Other Steps and Other Units>

Antistatic Step and Antistatic Unit

The antistatic step is a step of removing static electricity by applying an antistatic bias to a latent image bearing member and can be appropriately carried out by the antistatic unit.

The antistatic unit is not particularly limited, any unit can be adopted as long as it can apply an antistatic bias to a latent image bearing member, and the antistatic unit can be appropriately selected from among known antistatic devices. A preferable example thereof is an antistatic lamp.

Cleaning Step and Cleaning Unit

The cleaning step is a step of removing toner remaining on a latent image bearing member and can be appropriately carried out by the cleaning unit.

The cleaning unit is not particularly limited, any unit can be adopted as long as it can remove electrophotographic toner remaining on a latent image bearing member, and the cleaning unit can be appropriately selected from among known cleaners. Preferable examples thereof are a magnetic brush cleaner and a blade cleaner.

Recycling Step and Recycling Unit

The recycling step is a step of recycling toner removed at the cleaning step to a developing unit and can be appropriately carried out by the recycling unit.

The recycling unit is not particularly limited and an example thereof is a known conveying unit.

Controlling Step and Controlling Unit

The controlling step is a step of controlling the steps and can be appropriately carried out by the controlling unit.

The controlling unit is not particularly limited as long as it can control the movement of the above unit and can be appropriately selected depending on the purpose. Examples thereof are such devices as a sequencer and a computer.

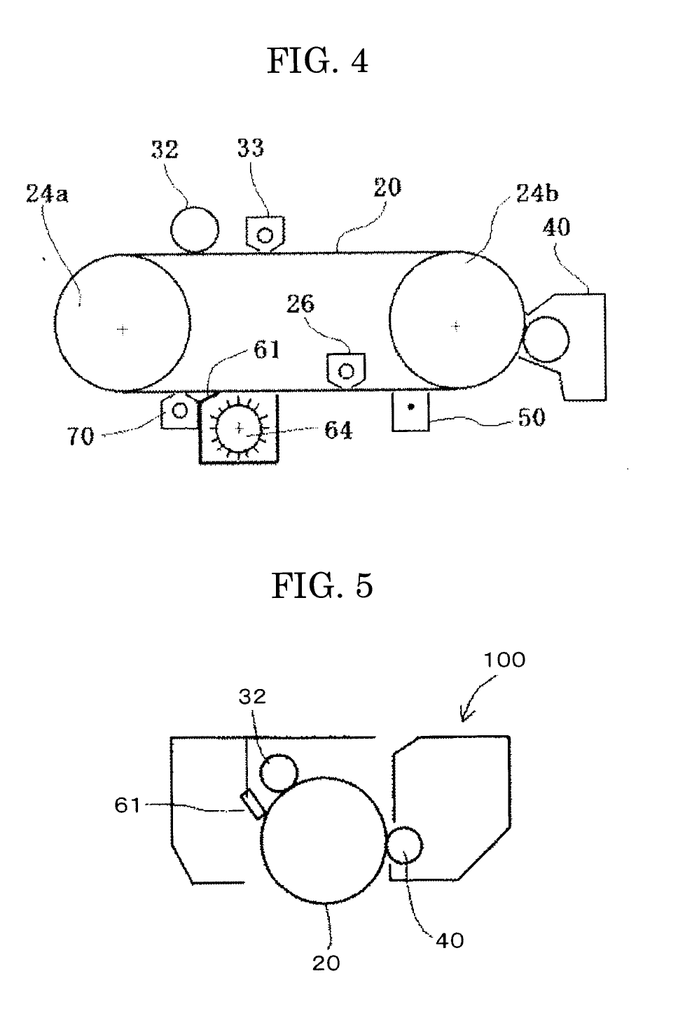

Here, FIG. 4 is a schematic view showing an example of an image forming apparatus that uses a developing roller according to the present invention.

A latent image bearing member (photoconductor) 20 has at least a photoconductive layer formed on an electrically-conductive substrate. The latent image bearing member (photoconductor) 20 is driven with driving rollers 24a and 24b and electrification through the use of a charging roller 32, image exposure with a light source 33, development by a developing unit 40 with a developing roller, transfer through the use of an charger 50, exposure before cleaning with a light source 26, cleaning by a brush-shaped cleaning unit 64 through the use of a cleaning blade 61, and static electricity elimination with an antistatic light source 70 are carried out repeatedly. Meanwhile, in FIG. 4, the latent image bearing member (photoconductor) 20 is irradiated with light from the side of the substrate, as exposure before cleaning (naturally, the substrate is translucent in this case).

### (Process Cartridge)

A process cartridge according to the present invention has at least a latent image bearing member that supports an electrostatic latent image and a developing unit for developing the electrostatic latent image supported on the latent image bearing member through the use of a developer to form a visible image, and further has other unit such as a charging unit, a developing unit, a transfer unit, a cleaning unit, and an antistatic unit, those being appropriately selected if necessary.

Preferably, a process cartridge according to the present invention can be detachably attached to each of various electrophotographic image forming apparatus, a facsimile, and a printer, and further can be detachably attached to an image forming apparatus according to the present invention.

FIG. 5 is a schematic view showing an example of a process cartridge 100.

The process cartridge 100 in FIG. 5 has a latent image bearing member (photoconductor) 20, a proximity-type brush-shaped contact charging unit 32, a developing unit 40 that stores a developer, and a cleaning unit including at least a cleaning blade 61 as a cleaning unit. In the present invention, it is possible to form a process cartridge by integrally combining the above constituent components and configure the process cartridge so as to be detachably attached to an image forming apparatus main body such as a copier or a printer.

### EXAMPLES

Hereinafter, the present invention will be explained in detail on the basis of examples but the present invention is not limited to the examples below.

### Comparative Example 1

### Fabrication of Developing Roller

Fabrication of Roller Base

Epichlorohydrin rubber (HYDRIN T3106 manufactured by Zeon Corporation) was coated on the surface of a metallic shaft having a diameter of 6 mm, and an elastic layer having a thickness of 3 mm is formed. A roller base was prepared by roughly polishing the surface of the obtained elastic layer with a polishing machine for rubber roller (LEO-600-F4L-BME manufactured by Minakuchi Machinery Works Ltd.) and further polishing it with a polishing machine (SZC manufactured by Minakuchi Machinery Works Ltd.).

Preparation of Toner Bearing Layer Coating Liquid 1

A toner bearing layer coating liquid 1 was prepared by blending the following materials and adding a catalyst (NEOSTAN U-820 manufactured by Nitto Kasei Co., Ltd.) by 0.5 part by mass;
Isocyanurate compound of hexamethylene diisocyanate (D170N manufactured by Mitsui Chemicals, Inc.): 1 part by mass,
Polyurethane polyol (A2789 manufactured by Mitsui Chemicals, Inc.): 5.52 parts by mass,
Carbon black (manufactured by Fuji Pigment Co., Ltd.): 5.2 parts by mass,
Organic spherical particles (IX-3-TM20 manufactured by Nippon Shokubai Co., Ltd.): 0.59 part by mass,
Methyl ethyl ketone: 5.52 parts by mass,
Butyl acetate: 9 parts by mass, and
Ethyl acetate: 81 parts by mass.

Forming Toner Bearing Layer

A developing roller 1 having a diameter of 12 mm was prepared by: applying a toner bearing layer coating liquid 1 on the elastic layer of the roller base by spray coating; annealing and thermosetting it at 130° C. for 0.5 hour and at 145° C. for 1 hour; and thus forming a toner bearing layer having a thickness of 5 μm to 6 μm.

### Example 1

### Fabrication of Developing Roller

A developing roller 2 was fabricated in the same manner as Comparative Example 1 except that the toner bearing layer coating liquid 1 in Comparative Example 1 was replaced with a toner bearing layer coating liquid 2 below.

Preparation of Toner Bearing Layer Coating Liquid 2

A toner bearing layer coating liquid 2 was prepared by blending the following materials and adding a catalyst (NEOSTAN U-820 manufactured by Nitto Kasei Co., Ltd.) by 0.5 part by mass;
Isocyanurate compound of hexamethylene diisocyanate (D170N manufactured by Mitsui Chemicals, Inc.): 1 part by mass,
Polyurethane polyol (A2789 manufactured by Mitsui Chemicals, Inc.): 3.45 parts by mass,
Carbon black (manufactured by Fuji Pigment Co., Ltd.): 3.7 parts by mass,
Organic spherical particles (IX-3-TM20 manufactured by Nippon Shokubai Co., Ltd.): 0.42 part by mass,
Methyl ethyl ketone: 3.45 parts by mass,
Butyl acetate: 6 parts by mass, and
Ethyl acetate: 54 parts by mass.

### Example 2

### Fabrication of Developing Roller

A developing roller 3 was fabricated in the same manner as Comparative Example 1 except that the toner bearing layer coating liquid 1 in Comparative Example 1 was replaced with a toner bearing layer coating liquid 3 below.

Preparation of Toner Bearing Layer Coating Liquid 3

A toner bearing layer coating liquid 3 was prepared by blending the following materials and adding a catalyst (NEOSTAN U-820 manufactured by Nitto Kasei Co., Ltd.) by 0.4 part by mass;
Isocyanurate compound of hexamethylene diisocyanate (D170N manufactured by Mitsui Chemicals, Inc.): 1 part by mass,
Polyurethane polyol (A2789 manufactured by Mitsui Chemicals, Inc.): 0.69 part by mass,
Carbon black (manufactured by Fuji Pigment Co., Ltd.): 1.49 parts by mass,
Organic spherical particles (IX-3-TM20 manufactured by Nippon Shokubai Co., Ltd.): 0.18 part by mass,
Methyl ethyl ketone: 0.69 part by mass,
Butyl acetate: 2.5 parts by mass, and
Ethyl acetate: 22.5 parts by mass.

### Example 3

### Fabrication of Developing Roller

A developing roller 4 was fabricated in the same manner as Comparative Example 1 except that the toner bearing layer coating liquid 1 in Comparative Example 1 was replaced with a toner bearing layer coating liquid 4 below.

Preparation of Toner Bearing Layer Coating Liquid 4

A toner bearing layer coating liquid 4 was prepared by blending the following materials and adding a catalyst (NEOSTAN U-820 manufactured by Nitto Kasei Co., Ltd.) by 0.4 part by mass;
Isocyanurate compound of tolylene diisocyanate (D262 manufactured by Mitsui Chemicals, Inc.): 1 part by mass,
Polyurethane polyol (A2789 manufactured by Mitsui Chemicals, Inc.): 0.1 part by mass,
Carbon black (manufactured by Fuji Pigment Co., Ltd.): 0.56 part by mass,
Organic spherical particles (IX-3-TM20 manufactured by Nippon Shokubai Co., Ltd.): 0.06 part by mass,
Methyl ethyl ketone: 0.1 part by mass,
Butyl acetate: 1 part by mass, and
Ethyl acetate: 9 parts by mass.

### Example 4

### Fabrication of Developing Roller

A developing roller 5 was fabricated in the same manner as Comparative Example 1 except that the toner bearing layer coating liquid 1 in Comparative Example 1 was replaced with a toner bearing layer coating liquid 5 below.

Preparation of Toner Bearing Layer Coating Liquid 5

A toner bearing layer coating liquid 5 was prepared by blending the following materials and adding a catalyst (NEOSTAN U-820 manufactured by Nitto Kasei Co., Ltd.) by 0.3 part by mass;
Isocyanurate compound of hexamethylene diisocyanate (D170N manufactured by Mitsui Chemicals, Inc.): 1 part by mass,
Polyurethane polyol (A2789 manufactured by Mitsui Chemicals, Inc.): 0.46 part by mass,
Carbon black (manufactured by Fuji Pigment Co., Ltd.): 1.32 parts by mass,
Organic spherical particles (IX-3-TM20 manufactured by Nippon Shokubai Co., Ltd.): 0.15 part by mass,
Methyl ethyl ketone: 0.46 part by mass,
Butyl acetate: 1.9 parts by mass, and
Ethyl acetate: 20.1 parts by mass.

### Example 5

### Fabrication of Developing Roller

A developing roller 6 was fabricated in the same manner as Comparative Example 1 except that the toner bearing layer coating liquid 1 in Comparative Example 1 was replaced with a toner bearing layer coating liquid 6 below.

Preparation of Toner Bearing Layer Coating Liquid 6

A toner bearing layer coating liquid 6 was prepared by blending the following materials and adding a catalyst (NEOSTAN U-820 manufactured by Nitto Kasei Co., Ltd.) by 0.25 part by mass;
Isocyanurate compound of tolylene diisocyanate (D262 manufactured by Mitsui Chemicals, Inc.): 1 part by mass,
Polyurethane polyol (A2789 manufactured by Mitsui Chemicals, Inc.): 0.072 part by mass,
Carbon black (manufactured by Fuji Pigment Co., Ltd.): 0.54 part by mass,
Organic spherical particles (IX-3-TM20 manufactured by Nippon Shokubai Co., Ltd.): 0.06 part by mass,
Methyl ethyl ketone: 0.072 part by mass,
Butyl acetate: 0.9 part by mass, and
Ethyl acetate: 8.1 parts by mass.

### Example 6

### Fabrication of Developing Roller

A developing roller 7 was fabricated in the same manner as Comparative Example 1 except that the toner bearing layer coating liquid 1 in Comparative Example 1 was replaced with a toner bearing layer coating liquid 7 below.

Preparation of Toner Bearing Layer Coating Liquid 7

A toner bearing layer coating liquid 7 was prepared by blending the following materials and adding a catalyst (NEOSTAN U-820 manufactured by Nitto Kasei Co., Ltd.) by 0.2 part by mass;
Isocyanurate compound of hexamethylene diisocyanate (D170N manufactured by Mitsui Chemicals, Inc.): 1 part by mass,
Polyurethane polyol (A2789 manufactured by Mitsui Chemicals, Inc.): 0.276 part by mass,
Carbon black (manufactured by Fuji Pigment Co., Ltd.): 1.18 parts by mass,
Organic spherical particles (IX-3-TM20 manufactured by Nippon Shokubai Co., Ltd.): 0.13 part by mass,
Methyl ethyl ketone: 0.276 part by mass,
Butyl acetate: 2 parts by mass, and
Ethyl acetate: 18 parts by mass.

### Example 7

### Fabrication of Developing Roller

A developing roller 8 was fabricated in the same manner as Comparative Example 1 except that the toner bearing layer coating liquid 1 in Comparative Example 1 was replaced with a toner bearing layer coating liquid 8 below.

Preparation of Toner Bearing Layer Coating Liquid 8

A toner bearing layer coating liquid 8 was prepared by blending the following materials and adding a catalyst (NEOSTAN U-820 manufactured by Nitto Kasei Co., Ltd.) by 0.2 part by mass;
Isocyanurate compound of hexamethylene diisocyanate (D170N manufactured by Mitsui Chemicals, Inc.): 1 part by mass,
Polyurethane polyol (A2789 manufactured by Mitsui Chemicals, Inc.): 0.256 part by mass,
Carbon black (manufactured by Fuji Pigment Co., Ltd.): 1.16 parts by mass,
Organic spherical particles (IX-3-TM20 manufactured by Nippon Shokubai Co., Ltd.): 0.13 part by mass,
Methyl ethyl ketone: 0.256 part by mass,
Butyl acetate: 2 parts by mass, and
Ethyl acetate: 18 parts by mass.

### Comparative Example 2

### Fabrication of Developing Roller

A developing roller 9 was fabricated in the same manner as Comparative Example 1 except that the toner bearing layer coating liquid 1 in Comparative Example 1 was replaced with a toner bearing layer coating liquid 9 below.

Preparation of Toner Bearing Layer Coating Liquid 9

A toner bearing layer coating liquid 9 was prepared by blending the following materials and adding a catalyst (NEOSTAN U-820 manufactured by Nitto Kasei Co., Ltd.) by 0.2 part by mass;
Isocyanurate compound of hexamethylene diisocyanate (D170N manufactured by Mitsui Chemicals, Inc.): 1 part by mass,
Polyurethane polyol (A2789 manufactured by Mitsui Chemicals, Inc.): 0.251 part by mass,
Carbon black (manufactured by Fuji Pigment Co., Ltd.): 1.16 parts by mass,
Organic spherical particles (IX-3-TM20 manufactured by Nippon Shokubai Co., Ltd.): 0.13 part by mass,
Methyl ethyl ketone: 0.251 part by mass,
Butyl acetate: 2 parts by mass, and
Ethyl acetate: 18 parts by mass.

### <Evaluation of Peak Intensity Ratio>

A ratio (A/B) of the absorbance A attributed to C═O in cyanurate to the absorbance B attributed to C═O in urethane was evaluated in the toner bearing layer of each of the developing rollers fabricated in Examples 1 to 7 and Comparative Examples 1 and 2. The results are shown in Table 1.

With regard to Examples 1 to 7 and Comparative Examples 1 and 2, samples were fabricated in the same manner as Examples 1 to 7 and Comparative Examples 1 and 2 except that only a toner bearing layer was formed in each case. The toner bearing layer was exfoliated from each of the fabricated samples and the surface of each of the toner bearing layers was analyzed through the use of an FT-IR (FT-IR Spectrometer manufactured by PerkinElmer Japan Co., Ltd.) and an ATR method.

Analysis Conditions

A universal ATR accessory was fixed. Each sample, which had been exfoliated from the developing roller by applying a cutter toward the metal core thereof, was set on the ATR crystal so that the toner bearing layer was brought into contact with the ATR crystal. Then, the press lever was moved onto the crystal and was made to apply pressure to the sample, to thereby measure an IR spectrum. Notably, the press lever was adjusted so that the pressure value shown in the monitor became 10, and the measurement was performed 8 times.

From an obtained IR spectrum, a single peak (the vicinity of 1,680 cm⁻¹ to 1,690 cm⁻¹) of C═O in cyanurate and a single peak (the vicinity of 1,710 cm⁻¹ to 1,730 cm⁻¹) of C═O in urethane were obtained, and the ratio (A/B) of the absorbance A of C═O in cyanurate to the absorbance B of C═O in urethane is calculated.

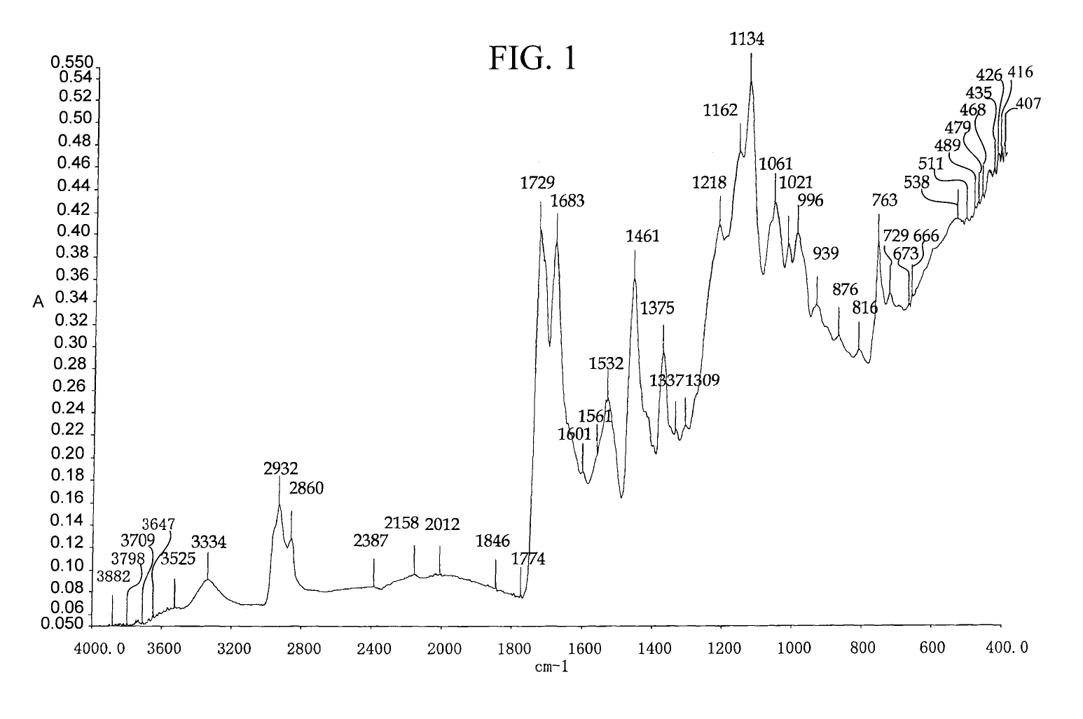

FIG. 1 shows the spectrum measured by an ATR method of the toner bearing layer of the developing roller fabricated in Comparative Example 1. From the result in FIG. 1, it was found that the absorbance A of the single peak (the vicinity of 1,680 cm⁻¹ to 1,690 cm⁻¹) of C═O in cyanurate is 0.301 and the absorbance B of the single peak (the vicinity of 1,710 cm⁻¹ to 1,730 cm⁻¹) of C═O in urethane is 0.322 in Comparative Example 1.

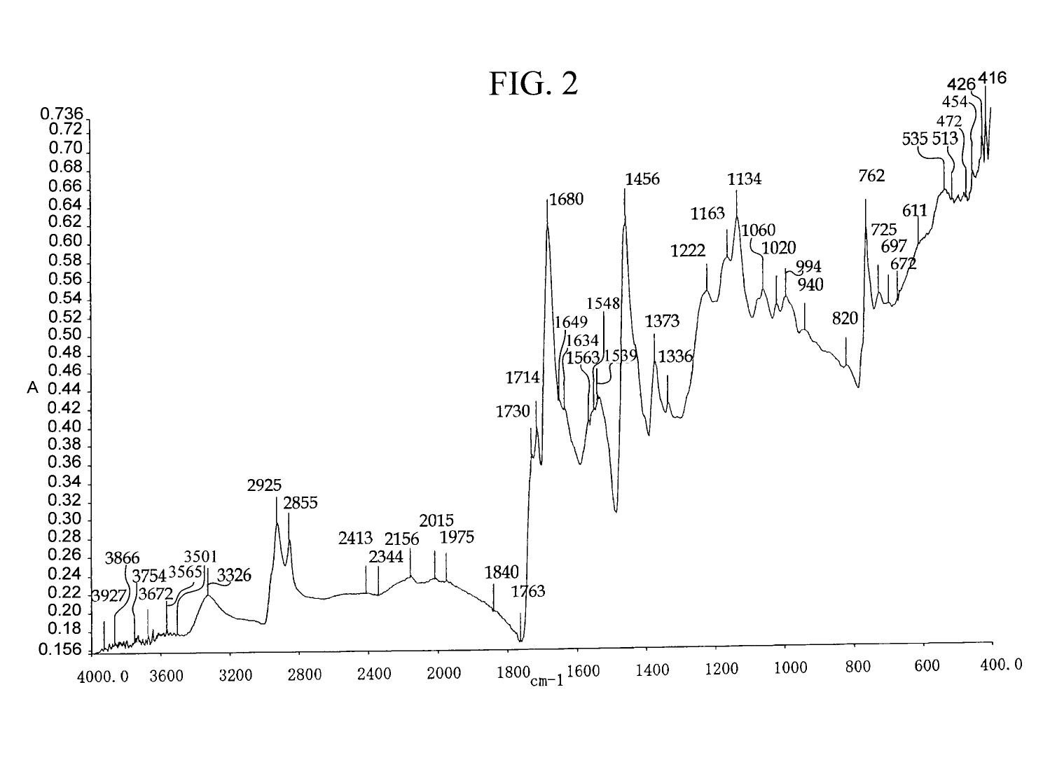

FIG. 2 shows the spectrum measured by an ATR method of the toner bearing layer of the developing roller fabricated in Example 2. From the result in FIG. 2, it was found that the absorbance A of the single peak (the vicinity of 1,680 cm⁻¹ to 1,690 cm⁻¹) of C═O in cyanurate is 0.410 and the absorbance B of the single peak (the vicinity of 1,710 cm⁻¹ to 1,730 cm⁻¹) of C═O in urethane is 0.180 in Example 2.

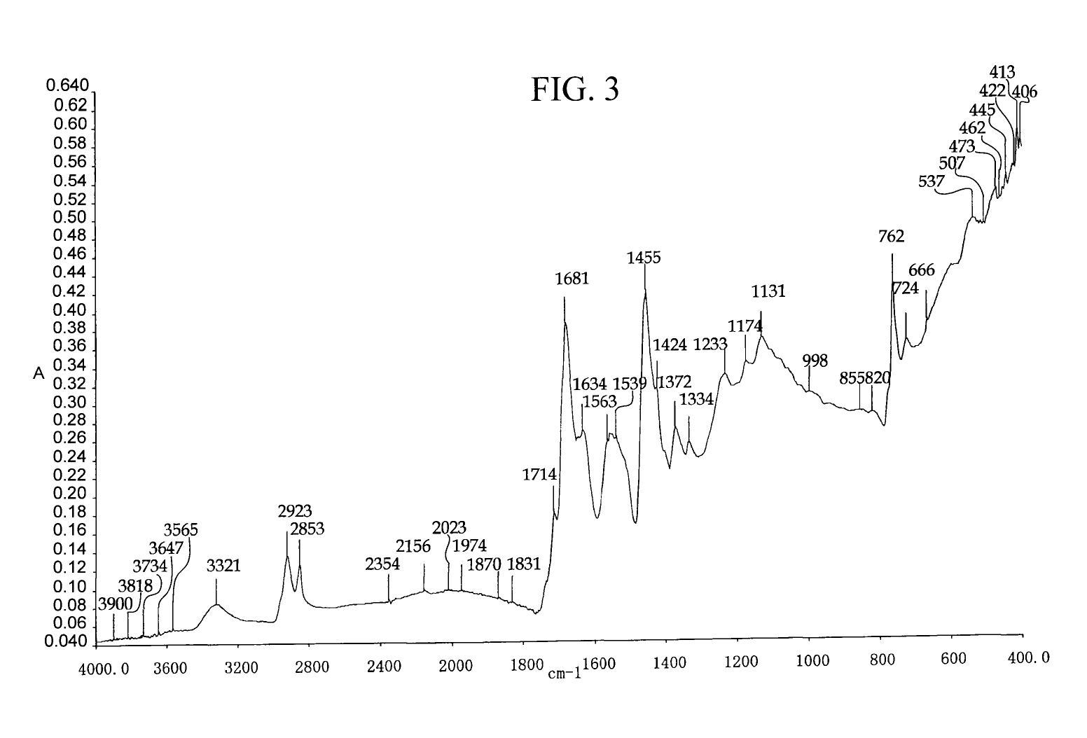

FIG. 3 shows the spectrum measured by an ATR method of the toner bearing layer of the developing roller fabricated in Example 6. From the result in FIG. 3, it was found that the absorbance A of the single peak (the vicinity of 1,680 cm⁻¹ to 1,690 cm⁻¹) of C═O in cyanurate is 0.263 and the absorbance B of the single peak (the vicinity of 1,710 cm⁻¹ to 1,730 cm⁻¹) of C═O in urethane is 0.033 in Example 6.

### <Image Lag Evaluation>

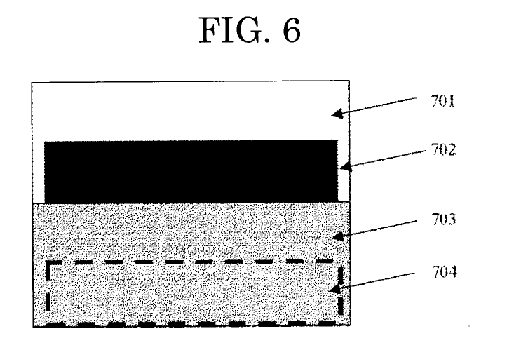

Image lag was evaluated based on the criteria below by visually observing the level of the image lag appearing in halftone images, after a predetermined print pattern having a B/W ratio of 6% had been continuously printed on 4,000 sheets of paper at a monochrome mode in an N/N environment (23° C., 45% RH) and an H/H environment (27° C., 80% RH) through the use of an image forming apparatus (IPSIO SP C310 manufactured by Ricoh Company, Ltd.) and then a solid pattern was printed with a pattern for image lag evaluation illustrated in FIG. 6. The results are shown in Table 1.

Note in FIG. 6 that a portion 701 is a white region, a portion 702 is a solid black region, a portion 703 is a halftone region, and a portion 704 is a region where image lag occurs due to the solid black region 702.

### [Evaluation Criteria]

AA: Image lag was not observed on images and there was no problem.

A: Image lag was observed on images to some extent but practically there was no problem.

B: Image lag was obviously generated on images and the level was practically problematic.

### <Evaluation of Background Smear>

Background smear was evaluated based on the criteria below by printing 4,500 sheets of a predetermined image pattern of a chart having an image concentration of 1% in an H/H environment (27° C., 80% RH) through the use of an image forming apparatus (IPSIO SP C310 manufactured by Ricoh Company, Ltd.); then attaching a mending tape (manufactured by Sumitomo 3M Limited) onto the surface of a photoconductor; transferring the background smear by toner existing on the photoconductor, onto the tape; attaching the mending tape and a not-attached mending tape on sheets of white paper respectively; measuring the reflection density of each sheet with a densitometer (X-RITE 939 manufactured by X-Rite, Inc.); and obtaining the difference L* as the reflection density of the background smear. The results are shown in Table 1.

### [Evaluation Criteria]

AA: L* after printing of 4,500 sheets satisfies the expression L*≧91.

A: L* after printing of 4,500 sheets satisfies the expression 91>L*≧90.

B: L* after printing of 4,500 sheets satisfies the expression 90>L*.

### <Storability Test>

A toner cartridge of an image forming apparatus (IPSIO SP C310 manufactured by Ricoh Company, Ltd.) was stored in an environment of 50° C. and 90% RH for one week and then transferred in an N/N environment (23° C., 50% RH) and left for one hour. After that, two sheets of halftone images, one sheet of a solid image, and again one sheet of a halftone image were printed continuously through the use of the image forming apparatus. Then, the storability was evaluated based on the criteria below by visually observing whether or not lateral streaks having a developing roller cycle were generated on the fourth sheet of the halftone image. The results are shown in Table 1.

### [Evaluation Criteria]

AA: No lateral streaks appeared at all on images.

A: Thin lateral streaks appeared on images but the level is practically not problematic.

B: Thick lateral streaks appeared on images and the level is practically problematic.

### <Tackiness Test>

Tackiness of a developing roller was evaluated as follows.

An acrylic plate (5 cm in width×30 cm in length, 30 mm in thickness) having a groove (12 mm in width×6 mm in depth), the size of the groove corresponding to the radius of a developing roller was prepared. Next, the developing roller was set along the groove. An angle of inclination at the time when the acrylic plate is gradually inclined and then the developing roller starts to slide was measured and the tackiness was evaluated based on the criteria below. The results are shown in Table 1.

Meanwhile, an angle of inclination at the time when a developing roller started to slide was likely to increase as the tackiness of the developing roller increased. Furthermore, the influences of a developing roller having tackiness are that: toner easily comes to be adherent; and the developing roller exfoliates or other members are damaged while unusual sound is generated due to friction with a member such as a regulation blade.

### [Evaluation Criteria]

AA: No tackiness (angle of inclination at the time when a developing roller starts to slide is 0° to 15°)

A: Little tackiness was observed but was at practically no problematic level (angle of inclination at the time when a developing roller starts to slide is 16° to 25°)

B: Tackiness was observed and was at a practically problematic level (angle of inclination at the time when a developing roller starts to slide is 26° to 90°)

TABLE 1

| | Molar ratio | Absorbance | | Background | | |
|---|---|---|---|---|---|---|
| | (NCO/OH) | ratio (A/B) | Image lag | smear | Storability | Tackiness |
| Ex. 1 | 8 | 1.0 | A | AA | A | A |
| Ex. 2 | 40 | 2.3 | A | AA | A | A |
| Ex. 3 | 50 | 2.7 | A | AA | A | A |
| Ex. 4 | 60 | 3.3 | AA | A | A | A |
| Ex. 5 | 70 | 4.2 | AA | A | AA | AA |
| Ex. 6 | 100 | 8.0 | AA | A | AA | AA |
| Ex. 7 | 108 | 10.0 | AA | A | AA | AA |
| Comp. | 5 | 0.9 | B | AA | B | B |
| Ex. 1 | | | | | | |
| Comp. | 110 | 10.4 | AA | B | AA | AA |
| Ex. 2 | | | | | | |

Aspects of the present invention are as follows.

<1> A developing roller including:
an electrically-conductive base,
an elastic layer formed on an outer circumference of the electrically-conductive base, and
a toner bearing layer formed on the elastic layer,
wherein the toner bearing layer contains a polyurethane resin having an isocyanurate structure, and
wherein the polyurethane resin has a ratio A/B of 1.0 to 10.0 where A denotes absorbance attributed to C═O of cyanurate and B denotes absorbance attributed to C═O of urethane in an infrared absorption spectrum of the polyurethane resin obtained by an ATR method.

<2> The developing roller according to <1>, wherein the polyurethane resin is a polymer of polyol and polyisocyanate prepolymer forming an isocyanurate compound.

<3> The developing roller according to <2>, wherein a ratio NCO/OH by mole of NCO groups in the polyisocyanate prepolymer to OH groups in the polyol is 8 to 108.

<4> The developing roller according to <2> or <3>, wherein the polyisocyanate prepolymer contains at least one selected from the group consisting of methylene diphenyl diisocyanate (MDI), tolylene diisocyanate (TDI), xylylene diisocyanate (XDI), naphthylene-1,5-diisocyanate (NDI), tetramethyl xylene diisocyanate (TMXDI), isophorone diisocyanate (IPDI), hydrogenated xylylene diisocyanate (H₆XDI), dicyclohexyl methane diisocyanate (H₁₂MDI), hexamethylene diisocyanate (HDI), dimer acid diisocyanate (DDI), norbornene diisocyanate (NBDI), trimethyl hexamethylene diisocyanate (TMDI), and isocyanurate compounds thereof.

<5> The developing roller according to <4>, wherein the polyisocyanate prepolymer contains at least one selected from the group consisting of tolylene diisocyanate, hexamethylene diisocyanate, and isocyanurate compounds thereof.

<6> A developing device including:
a developing roller configured to bear on a surface thereof a developer to be supplied to a latent image bearing member;
a developer supplying member configured to supply the developer onto the surface of the developing roller;
a developer layer regulating member configured to form a thin layer of the developer on the surface of the developing roller, and
a developer container which houses the developer,
wherein the developing roller is the developing roller according to any one of <1> to <5>.

<7> A process cartridge including:
a latent image bearing member; and
a developing unit configured to develop an electrostatic latent image on the latent image bearing member with a developer to form a visible image,
wherein the process cartridge is detachably mounted to the main body of an image forming apparatus, and
wherein the developing unit is the developing device according to <6>.

<8> An image forming apparatus including:
a latent image bearing member;
a charging unit configured to charge a surface of the latent image bearing member;
an exposing unit configured to expose the charged surface of the latent image bearing member to light to form an electrostatic latent image;
a developing unit configured to develop the electrostatic latent image with a developer to form a visible image;
a transfer unit configured to transfer the visible image to a recording medium; and
a fixing unit configured to fix the transferred image on the recording medium,
wherein the developing unit is the developing device according to <6>.

<9> A method for forming an image, the method including:
charging a surface of a latent image bearing member;
exposing the charged surface of the latent image bearing member to light to form an electrostatic latent image;
developing the electrostatic latent image with a developer to form a visible image;
transferring the visible image to a recording medium; and
fixing the transferred image on the recording medium,
wherein the developing is performed by the developing device according to <6>.

This application claims priorities to Japanese application No. 2011-060198, filed on Mar. 18, 2011 and Japanese application No. 2012-047856, filed on Mar. 5, 2012, and incorporated herein by reference.

What is claimed is:

1. A developing roller comprising:
an electrically-conductive base;
an elastic layer formed on an outer circumference of the electrically-conductive base; and
a toner bearing layer formed on the elastic layer,
wherein the toner bearing layer contains a polyurethane resin having an isocyanurate structure, and
wherein the polyurethane resin has a ratio A/B of 1.0 to 10.0 where A denotes absorbance attributed to C═O of cyanurate and B denotes absorbance attributed to C═O of urethane in an infrared absorption spectrum of the polyurethane resin obtained by an ATR method.

2. The developing roller according to claim 1, wherein the polyurethane resin is a polymer of polyol and polyisocyanate prepolymer forming an isocyanurate compound.

3. The developing roller according to claim 2, wherein a ratio NCO/OH by mole of NCO groups in the polyisocyanate prepolymer to OH groups in the polyol is 8 to 108.

4. The developing roller according to claim 2, wherein the polyisocyanate prepolymer contains at least one selected from the group consisting of methylene diphenyl diisocyanate (MDI), tolylene diisocyanate (TDI), xylylene diisocyanate (XDI), naphthylene-1,5-diisocyanate (NDI), tetramethyl xylene diisocyanate (TMXDI), isophorone diisocyanate (IPDI), hydrogenated xylylene diisocyanate (H₆XDI), dicyclohexyl methane diisocyanate (H₁₂MDI), hexamethylene diisocyanate (HDI), dimer acid diisocyanate (DDI), norbornene diisocyanate (NBDI), trimethyl hexamethylene diisocyanate (TMDI), and isocyanurate compounds thereof.

5. The developing roller according to claim 4, wherein the polyisocyanate prepolymer contains at least one selected from the group consisting of tolylene diisocyanate, hexamethylene diisocyanate, and isocyanurate compounds thereof.

6. A developing device comprising:
a developing roller configured to bear on a surface thereof a developer to be supplied to a latent image bearing member;
a developer supplying member configured to supply the developer onto the surface of the developing roller;
a developer layer regulating member configured to form a thin layer of the developer on the surface of the developing roller, and
a developer container which houses the developer,
wherein the developing roller comprises:
an electrically-conductive base,
an elastic layer formed on an outer circumference of the electrically-conductive base, and
a toner bearing layer formed on the elastic layer,
wherein the toner bearing layer contains a polyurethane resin having an isocyanurate structure, and
wherein the polyurethane resin has a ratio A/B of 1.0 to 10.0 where A denotes absorbance attributed to C═O of cyanurate and B denotes absorbance attributed to C═O of urethane in an infrared absorption spectrum of the polyurethane resin obtained by an ATR method.

7. An image forming apparatus comprising:
a latent image bearing member;
a charging unit configured to charge a surface of the latent image bearing member;
an exposing unit configured to expose the charged surface of the latent image bearing member to light to form an electrostatic latent image;
a developing unit configured to develop the electrostatic latent image with a developer to form a visible image;
a transfer unit configured to transfer the visible image to a recording medium; and
a fixing unit configured to fix the transferred image on the recording medium,
wherein the developing unit is a developing device which comprises:
a developing roller configured to bear on a surface thereof the developer to be supplied to the latent image bearing member;
a developer supplying member configured to supply the developer onto the surface of the developing roller;
a developer layer regulating member configured to form a thin layer of the developer on the surface of the developing roller, and
a developer container which houses the developer,
wherein the developing roller comprises:
an electrically-conductive base;
an elastic layer formed on an outer circumference of the electrically-conductive base; and
a toner bearing layer formed on the elastic layer,
wherein the toner bearing layer contains a polyurethane resin having an isocyanurate structure, and
wherein the polyurethane resin has a ratio A/B of 1.0 to 10.0 where A denotes absorbance attributed to C═O of cyanurate and B denotes absorbance attributed to C═O of urethane in an infrared absorption spectrum of the polyurethane resin obtained by an ATR method.
